(19) United States
(12) Patent Application Publication
(10) Pub. No.: US 2016/0140135 A1
(43) Pub. Date: May 19, 2016

(54) METHOD AND ADJUSTMENT DEVICE FOR ADAPTIVELY ADJUSTING DATABASE STRUCTURE

(71) Applicant: INSTITUTE FOR INFORMATION INDUSTRY, Taipei City (TW)

(72) Inventors: YUNG-CHUNG KU, HSINCHU COUNTY (TW); TSUNG-JUNG TSAI, NEW TAIPEI CITY (TW); LEE-CHUNG CHEN, NEW TAIPEI CITY (TW)

(21) Appl. No.: 14/563,493

(22) Filed: Dec. 8, 2014

(30) Foreign Application Priority Data
Nov. 19, 2014 (TW) 103140036

(51) Int. Cl. G06F 17/30

(52) U.S. Cl. CPC G06F 17/30091; G06F 17/30182

(57) ABSTRACT

A method and an adjustment device for adaptively adjusting a database structure are provided. The adjustment device is arranged between a client and a database. The client generates a database instruction and transmits the database instruction to the database. The database executes the database instruction and accordingly generates an interpretable execution result to the adjustment device. The adjustment device determines whether the database structure needs to be adjusted. When the database structure needs to be adjusted, the adjustment device adjusts the database structure configured in the database according to the execution result. When the database structure needs not to be adjusted, the adjustment device transmits the execution result back to the client. Accordingly, when the engineer develops an application system, they do not consider whether to redesign the new database structure, thereby the method and the adjustment device can improve the system development efficiency.

### BACKGROUND

1. Technical Field

The present disclosure relates to a method and an adjustment device for adjusting a database structure, in particular, to a method and an adjustment device for adaptively adjusting a database structure.

2. Description of Related Art

At present, the database structure in the database is mostly the customization. The customized database structure is used for arranging and managing the data in the database. The relationship among the data is generated by the column information of the table for each data. The engineer can use the database instruction (e.g., structured query language (SQL) instruction) for storing, querying, and acquiring the above data with the customized database structure.

However, when the customized database structure is requested from the unexpected data, the database structure should be redesigned as a new database structure (e.g., declaring the column information of the table for new data) for storing, querying, and acquiring the new data. When the redesigning or repairing the database structure is repeated often, man-powers may consume away with time and then the system development efficiency is reduced. Thereby, when the database structure is requested from the new data and can be adjusted to fit the new data automatically, it may improve the system development efficiency.

To address the above issues, the inventor strives via associated experience and research to present the instant disclosure, which can effectively improve the limitation described above.

### SUMMARY

An exemplary embodiment of the instant disclosure provides a method for adaptively adjusting a database structure, which is adapted for an adjustment device. The adjustment device is linked between a database and a client and the database has the database structure. The method for adaptively adjusting the database structure is as follow: (a) receiving an execution result generated from a database, wherein the database executes a database instruction from the client to generate the execution result; and (b) determining whether the execution result has an error message generated because the database structure does not match the database instruction, wherein when the execution result has the error message generated because the database structure does not match the database instruction, adjusting the database structure according to the error message, and when the execution result does not have the error message generated because the database structure does not match the database instruction, transmitting the execution result back to the client.

An exemplary embodiment of the instant disclosure provides an adjustment device for adaptively adjusting a database structure. The adjustment device is linked between a database and a client and the database has the database structure. The adjustment device includes a database engine. The database engine is configured for receiving an execution result generated from a database and determining whether the execution result has an error message generated because the database structure does not match the database instruction, wherein the database executes a database instruction from the client to generate the execution result. When the database engine determines that the execution result has the error message generated because the database structure does not match the database instruction, the database engine adjusts the database structure according to the error message. When the database engine determines that the execution result does not have the error message generated because the database structure does not match the database instruction, the database engine transmits the execution result back to the client.

To sum up, the exemplary embodiments of the instant disclosure provide a method and an adjustment device for adaptively adjusting a database structure, which can automatically adjust the needed database structure after the engineer inputting the database instruction to the adjustment device, thereby the adjusted database structure can match the database instruction to reduce the time of the engineer designing the new database structure. Accordingly, when the engineer develops an application system, they do not consider whether to redesign the new database structure, thereby the method and the adjustment device for adaptively adjusting the database structure can improve the system development efficiency.

In order to further understand the techniques, means and effects of the present disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of an adjustment device configured between a client and a database according to an exemplary embodiment of the instant disclosure.

FIG. 2A is a block diagram of a database structure according to an exemplary embodiment of the instant disclosure.

FIG. 2B is a block diagram of a database structure according to another exemplary embodiment of the instant disclosure.

FIG. 2C is a block diagram of a database structure according to another exemplary embodiment of the instant disclosure.

FIG. 2D is a block diagram of a database structure according to another exemplary embodiment of the instant disclosure.

FIG. 3 is a process flow diagram of a method for adjusting a database structure according to an exemplary embodiment of the instant disclosure.

### DESCRIPTION OF THE EXEMPLARY EMBODIMENTS

Reference will now be made in detail to the exemplary embodiments of the instant disclosure, examples of which are illustrated in the accompanying drawings. However, they may be embodied in different forms and should not be construed as being limited to the embodiments set forth herein. Wherever possible, the same reference numbers are used in the drawings and the description to refer to the same or like parts.

The instant disclosure provides a method and an adjustment device for adaptively adjusting a database structure. The adjustment device is linked between a client and a database. The client (such as terminal devices, electronic devices, computers, or etc.) can generate and send a database instruction (e.g., the structured query language, SQL) to the database. Then the database executes the database instruction to generate interpretable information to the adjustment device for determining whether the database structure needs to be adjusted. When the database structure needs to be adjusted, the adjustment device adjusts the database structure configured in the database according to the interpretable information. When the database structure needs not to be adjusted, the adjustment device transmits the interpretable information back to the client, to provide the engineer executing the following processing procedure. In other words, as long as the database instruction does not match the instant database structure, the adjustment device automatically adjusts the database structure configured in the database to match the database instruction transmitted from the client.

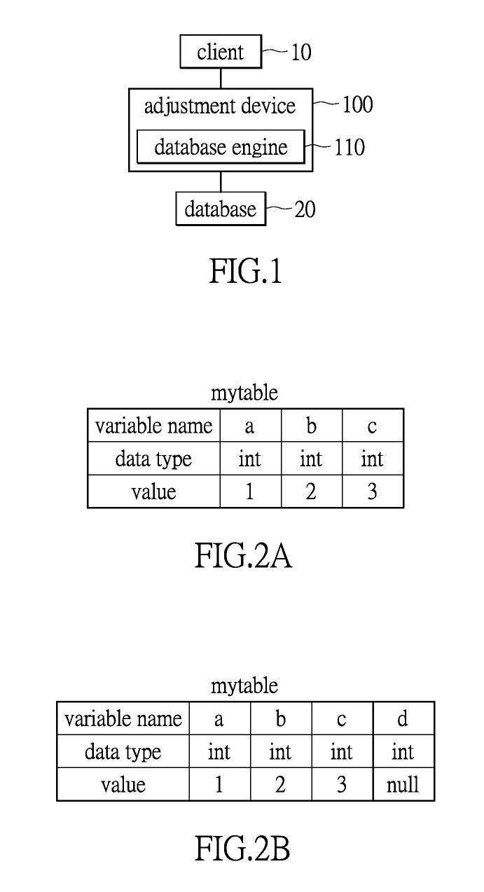

Firstly, please refer to FIG. 1, which shows a block diagram of an adjustment device configured between a client and a database according to an exemplary embodiment of the instant disclosure. As shown in FIG. 1, the adjustment device 100 is linked between a database 20 and a client 10, and the database 20 stores the database structure. In the instant disclosure, the database structure is a database schema, which is used for describing the data stored in the database 20. The database structure can also be indexes or other descriptions related to the data in the database, and the instant disclosure is not limited thereto. Notably, the term “linked” refers to an indirect or direct electrical connection, whether wired or wirelessly connected to the internet, or a connection via a relay device, or the combination thereof

In the instant disclosure, the client 10 can be any of user devices (such as portable electronic devices, computers, public information workstations, interactive multimedia kiosks KIOSK or other mid-range devices, etc.). The adjustment device 100 receives the database instruction transmitted from the client 10 and transmits the database instruction to the database 20. The database instruction includes a function, a table name of at least one table, and a variable name of at least one variable in the table. The variable corresponds to a data type. The database instruction further includes a value of each variable. The specific implementation method for the function, the table name of at least one table, the variable name of at least on variable in the table, the data type, and the value of each variable which are configured in the database instruction will be described in the later embodiment, and further descriptions are hereby omitted.

In the instant disclosure, the database instruction, for example, can be a structured query language (SQL). The SQL instruction is commonly a database query language, and thus is not furthered disclosed. Other database query language which is compatible with the implementation of ANSI SQL can also be used. Moreover, the database query language of the instant embodiment is not limited to the examples provided herein. Besides, the database instruction generated from the client 10 can also be transmitted to the database 20 directly bypassing the adjustment device 100 (not shown in FIGs). The instant disclosure is not limited thereto.

Afterwards, the database 20 executes the database instruction and generates an execution result. In the instant disclosure, the execution result is interpretable information. For example, the database instruction is SQL instruction, as follows.
INSERT INTO mytable (a, b, c) VALUES (1, 2, 3)

In particular, the content of the execution result is “CREATE TABLE mytable (a int, b int, c int)” taken as the interpretable information. It means that the function of the database instruction indicates creating the table and the table name of the table is “mytable”. The variables in the table are “a”, “b”, and “c”. The data type of the variables “a”, “b”, and “c” is integer (i.e., “int”) data type. The values of the variables “a”, “b”, and “c” are respectively 1, 2, and 3. Moreover, the content of the above execution result can be the interpretable information having other descriptions, and the instant disclosure is not limited thereto.

Next, the database 20 transmits the interpretable execution result back to the database engine 110 of the adjustment device 100 for determining whether the database structure needs to be adjusted. Then the database engine 110 determines whether the execution result has an error message and the error message is generated because the database structure does not match the database instruction. When the database engine 110 determines that the execution result does not have the error message generated because the database structure does not match the database instruction, the database engine 110 transmits the execution result back to the client 10. It indicates that the present database structure matches the database instruction transmitted from the client 10. Conversely, when the database engine 110 determines that the execution result has the error message generated because the database structure does not match the database instruction, the database engine 110 adjusts the database structure according to the error message for matching the database instruction transmitted from the client 10.

In the instant disclosure, when the error message indicates that the table name of a specific table in the at least one table included in the database instruction does not exist in the database structure, the database engine 110 creates the variable name and the value of the variable of the specific table in the database structure of the database 20.

For example, the present database structure does not have any table and the client 10 transmits the database instruction, which is SQL instruction, as follows.
INSERT INTO mytable (a, b, c) VALUES (1, 2, 3)

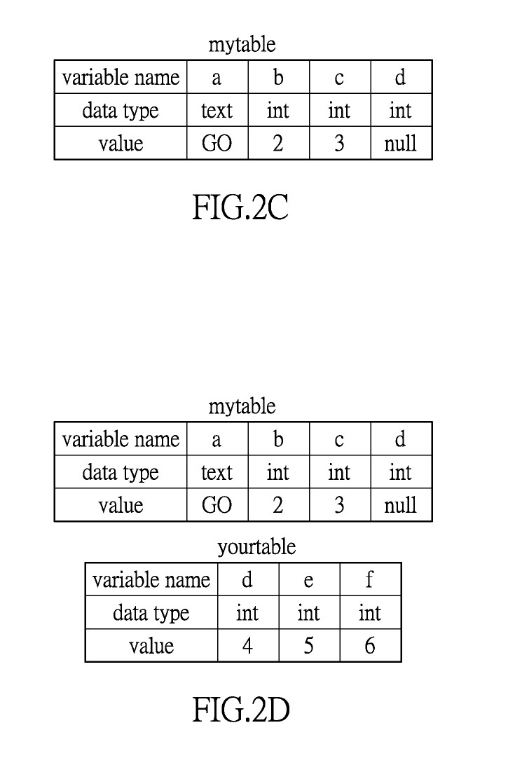

Then the database 20 executes the above database instruction, and accordingly generates the execution result “CREATE TABLE mytable (a int, b int, c int)” to the database engine 110. It means that the function of the database instruction indicates creating the table and the table name of the table is “mytable”. The variables in the table are “a”, “b”, and “c”. The data type of the variables “a”, “b”, and “c” is integer (i.e., “int”) data type. The values of the variables “a”, “b”, and “c” are respectively 1, 2, and 3. At present, the database engine 110 determines that the execution result has the error message and the error message indicates that the specific table of which the table name is “mytable” does not exist in the database structure. As shown in FIG. 2A, the database engine 110 then creates the specific table of which the table name is “mytable” according to the execution result and creates the relative information of the specific table.

In another disclosure, when the error message indicates that the variable of a specific table in the at least one table included in the database instruction is not declared in the database structure, the database engine 110 adds the variable name of the variable of the specific table in the database structure of the database 20.

Following the above example, the present database structure has the table as shown in FIG. 2A, i.e., the table of which the table name is “mytable”. The client 10 transmits the database instruction, which is SQL instruction, as follows.
SELECT a, c, d FROM mytable

Then the database 20 executes the above database instruction, and accordingly generates the execution result “ALTER TABLE mytable add column d int default null” to the database engine 110. It means that the function of the database instruction indicates altering the table of which the table name is “mytable”. A variable “d” having the integer data type is added into the variables of the table, and the value of the variable “d” is null. At present, the database engine 110 determines that the execution result has the error message and the error message indicates that the variable “d” having the integer data type does not exist in the table of which the table name is “mytable” of the database structure. As shown in FIG. 2B, the database engine 110 then adds the variable “d” having the integer data type into the table of which the table name is “mytable” according to the execution result and creates the relative information of the specific table.

Besides, in another disclosure, when the error message indicates that the data type of the variable of a specific table in the at least one table included in the database instruction does not match the data type of the variable declared in the database structure, the database engine 110 updates the data type and the value of the variable in the database structure of the database 20 according to the data type and the value of the variable in the specific table.

Following the above example, the present database structure has the table as shown in FIG. 2B, i.e., the table of which the table name is “mytable”. The client 10 transmits the database instruction, which is SQL instruction, as follows.
UPDATE mytable SET a=‘GO’ WHERE a=1

Then the database 20 executes the above database instruction, and accordingly generates the execution result “ALTER TABLE mytable alter column a type text” to the database engine 110. It means that the function of the database instruction indicates updating the integer (i.e., “int”) data type to the character (i.e., “text”) data type of the variable “a” in the table of which the table name is “mytable”, and the character of the variable “a” is “GO”. At present, the database engine 110 determines that the execution result has the error message and the error message indicates that the data type of the variable of a specific table included in the database instruction does not match the data type of the variable declared in the present database structure. As shown in FIG. 2C, the database engine 110 then updates the integer (i.e., “int”) data type to the character (i.e., “text”) data type of the variable “a” in the table of which the table name is “mytable”, and the character of the variable “a” is “GO” according to the execution result.

Following the same example, the client 10 again transmits the database instruction, which is SQL instruction, as follows.
INSERT INTO yourtable (d, e, f) VALUES (4, 5, 6)

Then the database 20 executes the above database instruction, and accordingly generates the execution result “CREATE TABLE yourtable (d int, e int, f int)” to the database engine 110. It means that the function of the database instruction indicates creating the table and the table name of the table is “yourtable”. The variables in the table are “d”, “e”, and “f”. The data type of the variables “d”, “e”, and “f” is integer (i.e., “int”) data type. The values of the variables “a”, “b”, and “c” are respectively 4, 5, and 6. At present, the database engine 110 determines that the execution result has the error message and the error message indicates that the specific table of which the table name is “yourtable” does not exist in the database structure of the database 20. As shown in FIG. 2D, the database engine 110 then creates the specific table of which the table name is “yourtable” according to the execution result and creates the relative information of the specific table.

The aforementioned error message can also be other error messages related to changing the database structure, and the instant disclosure is not limited thereto.

After adjusting the database structure according to the aforementioned error message, the database engine 110 re-determines whether the execution result has other error message, and the other error message is generated because the database structure does not match the database instruction. Simply, the database engine 110 again determines whether the adjusted database structure in the database 20 matches the database instruction transmitted from the client 10. At present, when the database engine 110 determines that the execution result does not have the error message generated because the database structure does not match the database instruction, the database engine 110 transmits the execution result back to the client 10. It indicates that the present database structure matches the database instruction transmitted from the client 10.

Accordingly, the exemplary embodiments of the instant disclosure provide the adjustment device for adaptively adjusting the database structure, which can automatically adjust the needed database structure in the database after the engineer inputting the database instruction to the adjustment device, thereby the adjusted database structure can match the database instruction transmitted from the client.

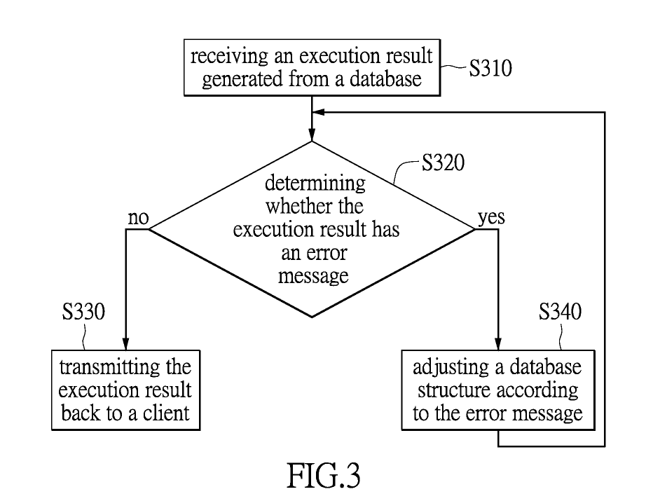

From the aforementioned exemplary embodiments, the instant disclosure may generalize a method for adaptively adjusting a database structure, which is adapted for the aforementioned adjustment device 100. Please refer to FIG. 3 in conjunction with FIG. 1. FIG. 3 shows a process flow diagram of a method for adjusting a database structure according to an exemplary embodiment of the instant disclosure. Firstly, the adjustment device 100 receives an execution result generated from the database 20 (Step S310). In the instant disclosure, the database executes a database instruction transmitted from the client 10 to generate the execution result. It is worth to note that the content of the execution result is the interpretable information, so that the adjustment device 100 can execute the further determination according to the interpretable information. The implementation manner for the relationship between the database instruction and the execution result has been illustrated in the above embodiment, so the redundant information is not repeated herein.

Afterwards, the adjustment device 100 determines whether the execution result has an error message, and the error message is generated because the database structure does not match the database instruction (Step S320). The implementation manner for determining the relationship between the execution result and the error message has been illustrated in the above embodiment, so the redundant information is not repeated herein. At this moment, when the adjustment device 100 determines that the execution result does not have the error message generated because the database structure does not match the database instruction, the adjustment device 100 transmits the execution result back to the client 10. It means that the present database structure matches the database instruction transmitted from the client 10 (Step S330).

Conversely, when the adjustment device 100 determines that the execution result has the error message generated because the database structure does not match the database instruction, the adjustment device 100 adjusts the database structure according to the error message (Step S340). After Step S340, the adjustment device 100 then re-determines whether the execution result has other error message, and the other error message is generated because the database structure does not match the database instruction. When the adjustment device 100 determines that the execution result does not have the error message, the adjustment device 100 transmits the execution result back to the client 10. It means that the present database structure matches the database instruction transmitted from the client 10 (Step S330). The implementation manner for the adjustment device 100 adjusting the database structure according to the error message has been illustrated in the above embodiment, so the redundant information is not repeated herein.

In summary, the exemplary embodiments of the instant disclosure provide the method and the adjustment device for adaptively adjusting the database structure, which can automatically adjust the needed database structure after the engineer inputting the database instruction to the adjustment device, thereby the adjusted database structure can match the database instruction to reduce the time of the engineer designing the new database structure. Accordingly, when the engineer develops an application system, they do not consider whether to redesign the new database structure, thereby the method and the adjustment device for adaptively adjusting the database structure can improve the system development efficiency.

The above-mentioned descriptions represent merely the exemplary embodiment of the instant disclosure, without any intention to limit the scope of the instant disclosure thereto. Various equivalent changes, alterations or modifications based on the claims of instant disclosure are all consequently viewed as being embraced by the scope of the instant disclosure.

What is claimed is:

1. A method for adaptively adjusting a database structure, adapted for an adjustment device, the adjustment device linked between a database and a client, the database having the database structure, and the method comprising:
(a) receiving an execution result generated from a database, wherein the database executes a database instruction from the client to generate the execution result; and
(b) determining whether the execution result has an error message generated because the database structure does not match the database instruction, wherein when the execution result has the error message generated because the database structure does not match the database instruction, adjusting the database structure according to the error message, and when the execution result does not have the error message generated because the database structure does not match the database instruction, transmitting the execution result back to the client.

2. The method according to claim 1, wherein the database instruction comprises a function, a table name of at least one table, and a variable name of at least one variable in the table, wherein the variable corresponds to a data type.

3. The method according to claim 2, wherein the database structure further comprises a value of the variable.

4. The method according to claim 3, wherein in the step (b), when the error message indicates that the table name of a specific table in the at least one table included in the database instruction does not exist in the database structure, creating the variable name and the value of the variable of the specific table in the database structure.

5. The method according to claim 2, wherein in the step (b), when the error message indicates that the variable of a specific table in the at least one table included in the database instruction is not declared in the database structure, adding the variable name of the variable of the specific table in the database structure.

6. The method according to claim 3, wherein in the step (b), when the error message indicates that the data type of the variable of a specific table in the at least one table included in the database instruction does not match the data type of the variable declared in the database structure, updating the data type and the value of the variable in the database structure according to the data type and the value of the variable in the specific table.

7. The method according to claim 1, wherein the database instruction uses an instruction-syntax and the instruction syntax is structured query language (SQL).

8. An adjustment device for adaptively adjusting a database structure, linked between a database and a client, the database having the database structure, and the adjustment device comprising:
a database engine, configured for receiving an execution result generated from a database and determining whether the execution result has an error message generated because the database structure does not match the database instruction, wherein the database executes a database instruction from the client to generate the execution result, when the database engine determines that the execution result has the error message generated because the database structure does not match the database instruction, adjusting the database structure according to the error message, and when the database engine determines that the execution result does not have the error message generated because the database structure does not match the database instruction, transmitting the execution result back to the client.

9. The adjustment device according to claim 8, wherein the database instruction comprises a function, a table name of at least one table, and a variable name of at least one variable in the table, wherein the variable corresponds to a data type.

10. The adjustment device according to claim 9, wherein the database structure further comprises a value of the variable.

11. The adjustment device according to claim 10, wherein when the error message indicates that the table name of a specific table in the at least one table included in the database instruction does not exist in the database structure, the database engine creates the variable name and the value of the variable of the specific table in the database structure.

12. The adjustment device according to claim 9, wherein when the error message indicates that the variable of a specific table in the at least one table included in the database instruction is not declared in the database structure, the database engine adds the variable name of the variable of the specific table in the database structure.

13. The adjustment device according to claim 10, wherein when the error message indicates that the data type of the variable of a specific table in the at least one table included in the database instruction does not match the data type of the variable declared in the database structure, the database engine updates the data type and the value of the variable in the database structure according to the data type and the value of the variable in the specific table.

14. The adjustment device according to claim 8, wherein the database instruction uses an instruction-syntax and the instruction syntax is structured query language (SQL).
